(19) United States
(12) Patent Application Publication
(10) Pub. No.: US 2013/0290360 A1
(43) Pub. Date: Oct. 31, 2013

(54) CONSUMABLE IDENTIFIER

(71) Applicants: John Cunningham, Naas (IE); Huston W. Rice, Vancouver, WA (US); David B. Novak, Philomath, OR (US); Declan Hynes, Celbridge (IE)

(72) Inventors: John Cunningham, Naas (IE); Huston W. Rice, Vancouver, WA (US); David B. Novak, Philomath, OR (US); Declan Hynes, Celbridge (IE)

(21) Appl. No.: 13/460,361

(22) Filed: Apr. 30, 2012

(51) Int. Cl. G06F 17/30; G06F 12/00

(52) U.S. Cl. 707/758; 711/154; 707/E17.014; 711/E12.001

(57) ABSTRACT

A consumable product can have an identifier stored on a circuit or machine-readable medium. The identifier can be used to verify the authenticity of the consumable product. The integrity of the identifier can be verified based on an integrity check portion of the identifier.

### BACKGROUND

A consumable is a product that is capable of being consumed or used up. Ink or toner printer cartridges are examples of consumables. An ink or toner printer cartridge can be inserted into a printer, such as an ink jet printer or a laser printer, and enable printing for a period of time, that is, until it is used up. After the ink or toner is used up, the user can discard the cartridge and purchase another one.

### BRIEF DESCRIPTION OF DRAWINGS

The following detailed description refers to the drawings, wherein:

FIG. 1 illustrates a consumable product having a unique identifier, according to an example.

FIG. 2 illustrates a unique identifier having various components, according to an example.

FIG. 3 illustrates a use case of authenticating a unique identifier on a printer cartridge, according to an example.

FIG. 4 illustrates a method of authenticating a printer cartridge using a unique identifier, according to an example.

FIG. 5 illustrates a method of checking the integrity of a unique identifier, according to an example.

FIG. 6 illustrates a method of manufacturing unique identifier circuits, according to an example.

FIG. 7 illustrates a method of incrementing a time interval during the manufacturing process, according to an example.

### DETAILED DESCRIPTION

Manufacturers of consumable products are challenged to come up with effective methods of encouraging customers to purchase authentic replacement consumable products. For example, in the field of printers, an Original Equipment Manufacturer (OEM) of printers often also manufactures toner or ink cartridges for its printers (hereinafter referred to as “printer cartridges”). However, some businesses manufacture their own brand of cartridges that may work with the OEM printer (hereinafter referred to as “clone cartridges”). Additionally, sometimes these businesses try to pass their clone cartridges off as authentic cartridges produced by the OEM (hereinafter referred to as “counterfeit cartridges”). It is in the interest of the manufacturer for customers to purchase authentic cartridges made by the manufacturer for many reasons. For example, OEM cartridges generally perform better on the OEM printers than clone cartridges or counterfeit cartridges. Thus, when a customer does not use an OEM cartridge, the printing experience may be less than satisfactory. Often times the customer will blame the OEM for the poor experience, especially if the customer unknowingly purchased a counterfeit cartridge. In addition, purchasing replacement cartridges from the OEM helps to build good will and customer loyalty.

According to an embodiment, identifier circuits can be manufactured for placement on consumable products. The identifier circuits can include a unique identifier that can be used to identify the consumable product as authentic, that is, as produced by the manufacturer. In addition, the unique identifier can be used as part of a rewards system in which the customer receives a reward for having purchased an authentic product. The unique identifiers can be generated such that it is difficult for a competitor to generate counterfeit unique identifiers for use on the competitors consumable products. For example, the unique identifiers can be unique in that the identifier is not used more than once over a given period of time. That way a competitor cannot create a seemingly authentic counterfeit consumable by simply recycling unique identifiers on discarded consumable products produced by the original manufacturer. Additionally, the unique identifier can be generated from a sufficiently large number space in a sufficiently random way such that the likelihood of guessing a valid unique identifier is low.

In one example, the unique identifier can have a random portion generated by a random number generator and a time portion indicating a time period during which the identifier was generated. Additionally, the unique identifier can have an integrity check portion that can be used to verify the integrity of the identifier without having to compare the identifier to a list of valid identifiers. The unique identifier can be stored on a circuit and attached to the consumable product, such as a printer cartridge. The circuit can be configured to be read by another product that uses the consumable product, such as a printer. In this way, the consumable product may be uniquely identifiable as an authentic product and a customer may be rewarded for purchasing an authentic product. Further details of this embodiment and associated advantages, as well as of other embodiments, will be discussed in more detail below with reference to the drawings.

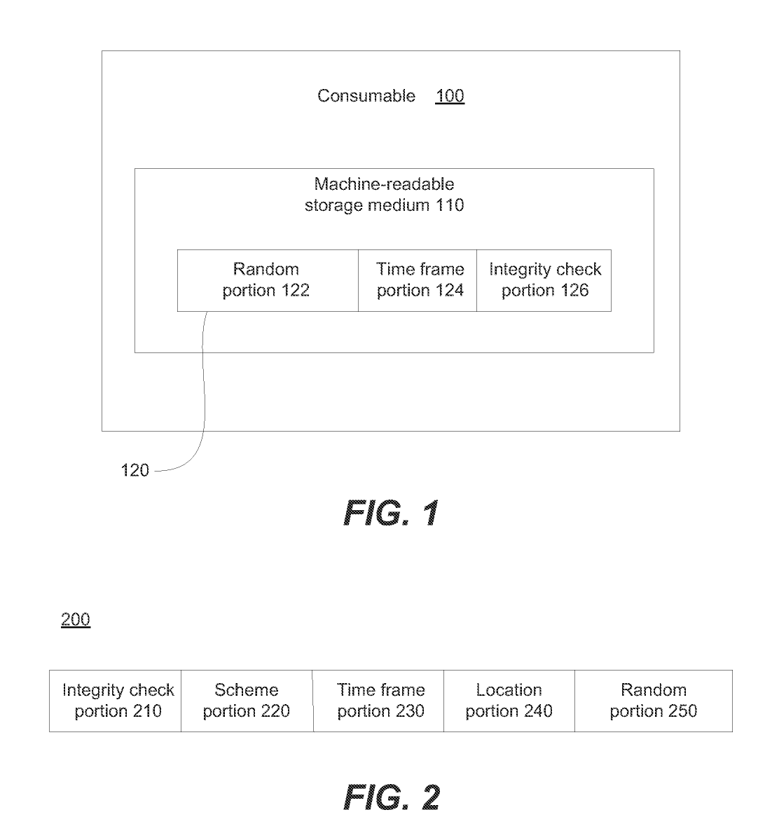

Referring now to the drawings, FIG. 1 illustrates a consumable product having a unique identifier, according to an example. Consumable product 100 can be any of various consumable products. For example, the consumable product can be a printer cartridge, a computer component such as a memory, or the like. If the consumable product is an Inkjet printer cartridge, the cartridge can be an integrated cartridge that combines a print head with the ink supply container or it can be solely an ink supply container.

Consumable product 100 can have a machine-readable storage medium 110. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. In one example, if consumable product 100 is a printer cartridge, machine-readable storage medium 110 may be an EEPROM. The EEPROM may constitute memory already provided on the printer cartridge for other purposes, such as for identifying the type of ink (color or black ink), the size of the ink reservoir, or the like.

Machine-readable storage medium 110 may store a unique identifier 120. Unique identifier 120 can identify consumable 100 as an authentic consumable, that is, a consumable produced by a certain manufacturer, such as an OEM. Unique identifier 120 can be any of various lengths. The length of unique identifier 120 should be sufficient to provide a large enough number space such that it is difficult for someone to randomly generate a valid identifier. In one example, the unique identifier is 72 bits long. Of course, other lengths may be used as well. In some cases, additional memory (such as an additional EEPROM for a printer cartridge) beyond that which is normally included may be added to a consumable to accommodate the unique identifier.

Unique identifier 120 may include various components or portions. Unique identifier 120 may include a random portion 122. Random portion 122 may be a random number generated by a random number generator. Standard random number generators may be used, such as those provided by various programming language libraries. Alternatively, a more robust random number generator may be used that makes use of a standard random number generator in combination with one or more hashing functions, one-way functions, or the like. Random portion 122 may be any of various lengths. In one example, random portion 122 may extend for the length of the unique identifier after the other portions have been filled. As discussed below, since the other portions of the unique identifier 120 are generated according to a particular scheme that potentially may be guessed or discovered, it can be helpful for random portion 122 to be sufficiently long to provide an adequate degree of randomness to the unique identifier 120, so that unique identifier 120 is difficult to guess. In an example where the unique identifier 120 is 72 bits long, the random portion 122 may be 60 bits long. However, the random portion 122 may be shorter, such as 15 or 20 bits long, at the expense of the randomness of the unique identifier 120. Additionally, limiting the length of the random portion 122 may limit the number of unique identifiers that can be generated during a given time period. This may occur because the number space available for a unique identifier produced during a given time period can be dependent on the size of the random portion since the rest of the portions of the unique identifier may have identical values.

Unique identifier 120 may include a time frame portion 124. Time frame portion 124 may indicate a time period when the unique identifier was generated. By tracking the time period of generation and including the corresponding time frame portion in the unique identifier 120, the generation process of the unique identifiers can be made more efficient since uniqueness of the identifier can be verified by comparing the newly generated unique identifier with just the other unique identifiers that have been generated during the current time period, rather than having to compare the newly generated unique identifier with all unique identifiers generated to date. As a result, unique identifier 120 can be considered to be unique because it is not used more than once over a given period of time. Time frame portion 124 should be long enough to accommodate enough time periods such that when the time periods cycle through again, all of the consumables having unique identifiers made during the previous iteration of that time period have been used.

Unique identifier 120 may include an integrity check portion 126. Integrity check portion 126 may be used to verify the integrity of the unique identifier. This integrity verification process can be performed without consulting a list of all valid identifiers to determine whether the unique identifier is in the list. Rather, the integrity check portion 126 may be the result of an algorithm, such as a hash function, applied to part or all of the unique identifier 120. In other words, the integrity check portion 126 may be a type of checksum. Accordingly, to verify the integrity of the unique identifier 120, the same algorithm used to generate the integrity check portion 128 can be applied to the unique identifier and the result can be compared to the integrity check portion 126. Integrity checks may be performed during manufacturing to ensure quality. Integrity checks may also be performed as a first level verification of the consumable by the device using the consumable. For example, if consumable 100 is a printer cartridge, the integrity of the printer cartridge can be checked using the integrity check portion 124. In such an example, the firmware of the printer may store the algorithm to apply to the unique identifier and may compare the result to the integrity check portion 124. Thus, integrity—and to an extent, the authenticity—of the printer cartridge can be verified at the printer without consulting a database of valid unique identifiers.

FIG. 2 illustrates a unique identifier having various components, according to an example. Unique identifier 200 can be similar to unique identifier 120 and may be stored on a machine-readable medium of a consumable, as described above. Unique identifier 200 may have various components, including an integrity check portion 210, a time frame portion 230, and a random portion 250, also substantially as described above. Unique identifier 200 may further include a scheme portion 220 and a location portion 240.

Scheme portion 220 may indicate a scheme by which the unique identifier is configured to be interpreted. In particular, the scheme portion 220 may indicate to a device configured to use the consumable how to interpret the various components or portions of the unique identifier. For instance, the scheme portion may indicate the format of the unique identifier, the number of bits in the integrity check portion, the portion of the unique identifier to apply the integrity check algorithm to, or the like. In some examples, there can be multiple possible schemes for interpreting a unique identifier, where the appropriate scheme is selected and indicated via the scheme portion 220 at the time of generating the unique identifier. The scheme portion may also be used as a technique for changing the format of the unique identifier over time.

Location portion 240 may indicate a location at which the unique identifier was generated. For example, there may be multiple unique identifier generation systems which can be located in one or more locations. It can be useful to keep track of which system generated the identifier because each system may not be aware of the unique identifiers generated by the other system. This may especially be the case for security reasons if the systems are located in different locations. Accordingly, the location portion 240 may be used to differentiate unique identifiers generated at the different locations and thus ensure that the two locations do not inadvertently generate identical unique identifiers.

Although specific examples of portions of unique identifiers have been provided in FIGS. 1 and 2, a unique identifier according to the disclosed embodiments may include other portions as well and/or may not include all of the disclosed portions. Additionally, the format and layout of the different portions within the unique identifier may be different from that shown in FIGS. 1 and 2, which are merely abstractions of the data that may constitute the unique identifiers.

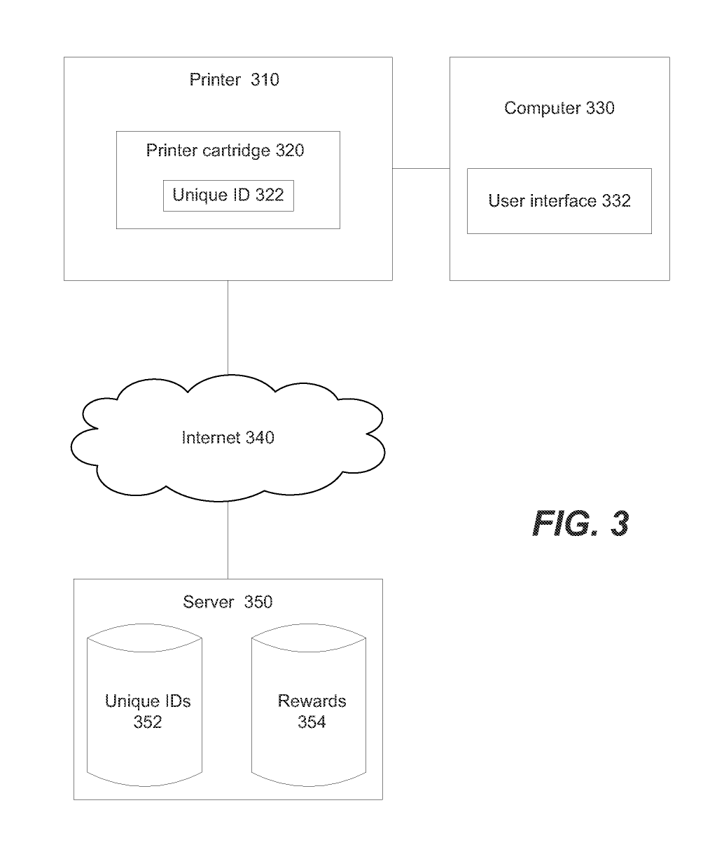

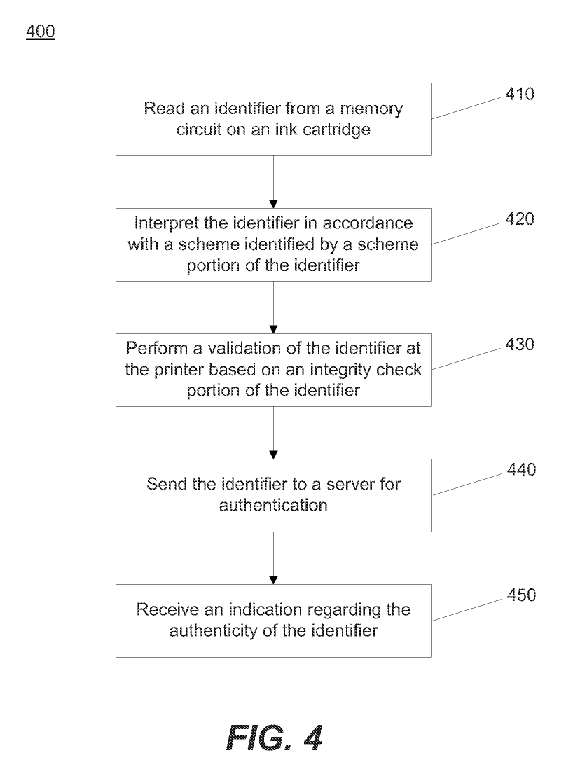

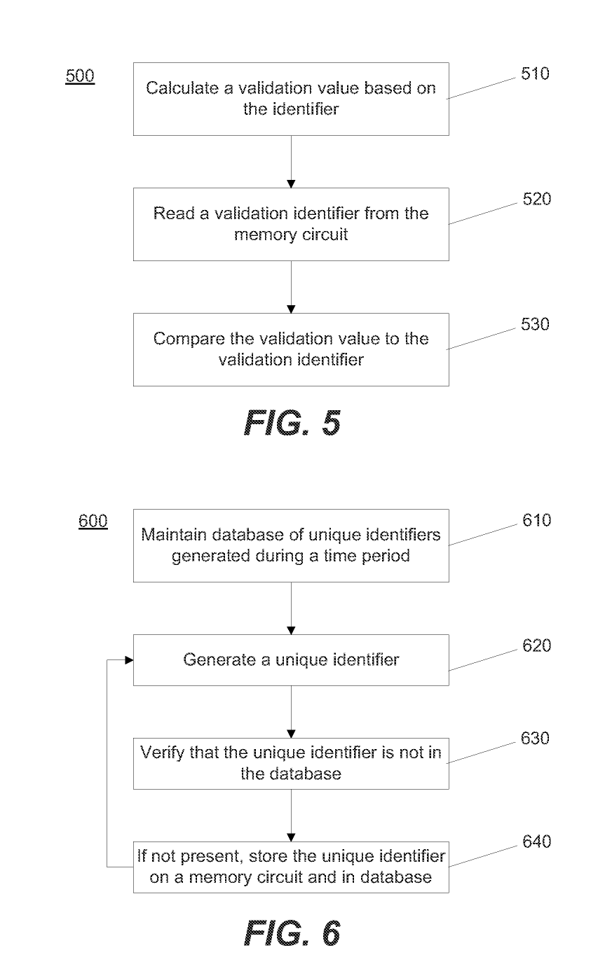

FIG. 3 illustrates a use case of authenticating a unique identifier on a printer cartridge, according to an example. Printer 310 may be any of various printers, such as an ink jet printer, and may include a processor, memory, and/or firmware. Printer 310 may have installed within it an printer cartridge 320 having a unique identifier 322. The unique identifier 322 may be stored on a machine-readable storage medium, as shown in FIG. 1. Printer 310 may be connected to a computer 330, which may include one or more processors and machine-readable storage mediums. Computer 330 may also include a various input and output device, such as a keyboard, mouse, and display. Computer 330 may provide a user interface 332 for interaction with a user. Printer 310 may be connected to a server 350 via the Internet 340. Server 350 may comprise one or more computers, located locally or remotely from each other. Server 350 may include a database 352 storing valid unique identifiers and a database 354 storing various rewards. A valid unique identifier is an identifier that was generated by or for the manufacturer of the printer cartridge 320. This use case will now be described with respect to FIGS. 4 and 5.

FIG. 4 illustrates a method 400 of authenticating a printer cartridge using a unique identifier, according to an example. Method 400 is described as being performed by printer 310.

Method 400 may begin at 410 where printer 310 may read unique identifier 322. The unique identifier 322 may be read from a memory circuit or machine-readable storage medium of printer cartridge 320. This can be done upon installation of printer cartridge 320 into printer 310, for example. At 420, printer 310 may read a scheme portion of unique identifier 322 to determine the appropriate scheme for interpreting the identifier. At 430, printer 310 may perform a validation of the identifier based on an integrity check portion of the identifier. Validation of the identifier is explained in more detail below with reference to FIG. 5.

At 440, the unique identifier 322 can be sent to server 350 for authentication. In one example, server 350 may authenticate unique identifier 322 by verifying that it is in database 352 of valid unique identifiers. The unique identifiers stored in database 352 may be considered to be valid identifiers because they correspond to identifiers generated during a manufacturing process. Server 350 may modify database 352 to indicate that the unique identifier corresponding to unique identifier 322 has been authenticated, thus removing it from the list of valid identifiers. In addition, if the unique identifier is authentic, server 350 may select one or more rewards offers from rewards database 354 to send to printer 310.

At 450, printer 310 can receive from server 350 an indication regarding the authenticity of the unique identifier 322. The indication may further include one or more rewards offers if the unique identifier was determined to be authentic. Accordingly, if the unique identifier 322 is authentic, a message regarding the authenticity of the printer cartridge 320 may be sent to computer 330 to be displayed to the user via user interface 332. Additionally, the rewards offer(s) may also be presented to the user via user interface 332. If the unique identifier is not authentic, a message may be sent to computer 330 and displayed on user interface 332 that the printer cartridge 320 is not authentic. In some examples, the printer cartridge 320 may also be rejected. A message may be sent to computer 330 and displayed on user interface 332 that the printer cartridge can't be used with printer 310 because it is not an authentic product and thus may not work properly. In another example, a message may be sent to server 350 containing location information of printer 310 or computer 330. This information may be used to investigate the source of counterfeit cartridges, for example.

FIG. 5 illustrates a method 500 of checking the integrity of a unique identifier, according to an example. Method 500 is described as being performed by printer 310. However, method 500 may also be performed during a manufacturing process, such as method 600, to verify the integrity of unique identifier circuits that have been produced. In one example, a circuit may be discarded if it fails the integrity check.

Method 500 may begin at 510 where printer 310 may calculate a validation value based on at least part of unique identifier 322. The validation value may be calculated using an algorithm stored in printer 310, such as in firmware. At 520, printer 310 may read a validation identifier from printer cartridge 320, such as from a memory circuit of printer cartridge 320. The validation identifier may be a part of unique identifier 322. In particular, the validation identifier may correspond to the integrity check portion described in FIGS. 1 and 2. At 530, printer 310 may compare the validation value to the validation identifier. If they match, the integrity of the unique identifier may be confirmed. If they do not match, the integrity of the unique identifier may be suspect. A failure may indicate that the printer cartridge 320 is a clone or counterfeit cartridge.

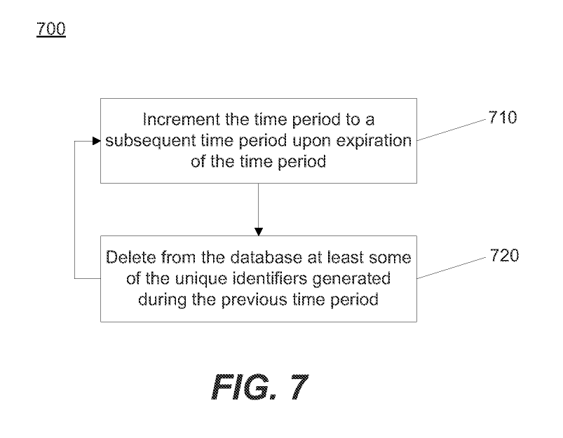

FIG. 6 illustrates a method of manufacturing unique identifier circuits, according to an example. At 610, a database can be maintained to store unique identifiers generated during the manufacturing process. This database can be distinct from the database 352 in FIG. 3, which can be used to authenticate unique identifiers and implement a rewards program. Specifically, the database used during the manufacturing process can be a working database used during manufacturing to reduce the risk of duplicating a unique identifier circuit. Additionally, as described with respect to FIG. 7, this database can be kept smaller than database 352. In particular, the database can be used to keep track of unique identifiers generated and placed on unique identifier circuits during a given time period rather than keep track of all unique identifiers in use. The time period may be a bounded period of manufacturing time associated with a batch of unique identifier circuits produced during the bounded period of manufacturing time. In one example, the bounded time period corresponds to two weeks of manufacturing time.

Blocks 620 through 640 may be performed for all unique identifier circuits to be produced during the current time period. At 620, a unique identifier can be generated. The unique identifier can be generated by one or more systems configured to generate unique identifiers. The systems may include one or more microprocessors and machine-readable storage mediums. The processors can execute instructions stored in the machine-readable storage mediums for generating the unique identifiers. The unique identifiers may include various components, as described in FIGS. 1 and 2. For instance, the unique identifiers may include an integrity check portion, a scheme portion, a time frame portion, a location portion, and a random portion, or some subset of these portions.

At 630, it can be determined whether the generated unique identifier is in the database. If the unique identifier includes a time portion, this determination may be performed more efficiently since the newly generated unique identifier may be compared with only the unique identifiers generated during the current time period. Thus, the number of unique identifiers to be searched may be much less than if all unique identifiers ever generated had to be checked. This also can have the benefit of reducing the size of the database.

At 640, if the newly generated unique identifier is not present in the database, the unique identifier may be stored on a unique identifier circuit. Additionally, the database may be updated to include the newly generated unique identifier. If the newly generated unique identifier is present in the database, this indicates that the unique identifier has already been placed on a previous unique identifier circuit, and the newly generated unique identifier may thus be discarded. If there are more unique identifier circuits to be produced during the current time period, method 600 may return to 620 to generate another unique identifier.

In some embodiments, the system(s) that generate unique identifiers may not follow method 600 exactly. For example, a batch of unique identifiers may be generated first before executing block 630 or 640. In some examples, one or more unique identifiers produced in the batch will not ultimately be used and may be discarded without executing block 630 or 640 with respect to the one or more unique identifiers.

It may be possible that one or more unique identifiers are duplicated during the manufacturing process. This can occur as a result of a software error, a manual error with regards to maintaining the database of generated unique identifiers, or the like. Duplicate unique identifiers may be detected in various ways, such as through investigation in the case of a known manual error. In addition, duplicate unique identifiers may also be detected when adding a batch of newly generated unique identifiers to the master database used for storing and authenticating unique identifiers, such as database 352 of FIG. 3. When a duplicate unique identifier is detected, the master database can be updated to reflect that the particular unique identifier is valid for two consumable products (or more if the unique identifier was produced more than twice). While this could potentially allow a competitor to be able to recycle a unique identifier from a discarded consumable, the likelihood of duplication may be so rare relative to the number of unique identifier circuits produced that the effective risk may be very low.

FIG. 7 illustrates a method of incrementing a time interval during the manufacturing process, according to an example. At 710, the current time period may be incremented to a subsequent time period upon expiration of the current time period. The subsequent time period thus becomes the new current time period. By incrementing the time period, the system that generates the unique identifiers can update the time frame portion to correspond to the subsequent time period. Thus, any unique identifiers generated during the subsequent time period may include the new time frame portion indicating the subsequent time period.

At 720, at least some unique identifiers generated during the previous time period may be deleted from the database. This deletion does not have to occur within any set time period from the incrementing of the time period. That is, the unique identifiers from the previous time period may be kept in the database for some time even after the manufacturing process is well into the subsequent time period. Eventually, however, at least some of the previous unique identifiers may be deleted since they are not required for checking the uniqueness of identifiers generated during the now current (subsequent) time period. After expiration of the current time period, method 700 may proceed to 710 to increment to another subsequent time period. Before deletion of the unique identifiers, however, they may be stored in another database. For example, the unique identifiers may be stored in the unique identifier database 352 of FIG. 3. Thus, the unique identifiers may be used to authenticate consumables on which the unique identifier circuits are placed.

1. A consumable product, comprising:
a machine-readable storage medium storing a unique identifier for verifying authenticity of the consumable product, the unique identifier comprising a random portion generated by a random number generator, a time frame portion indicating a time period when the unique identifier was generated, and an integrity check portion to verify integrity of the unique identifier.

2. The consumable product of claim 1, wherein the consumable product is a cartridge for an inkjet printer.

3. The consumable product of claim 1, wherein the unique identifier further comprises a scheme portion indicating a scheme by which the unique identifier is configured to be interpreted.

4. The consumable product of claim 1, wherein the unique identifier further includes a location portion indicating a location at which the unique identifier was generated

5. The consumable product of claim 1, wherein the machine-readable medium is configured to be read by a device configured to use the consumable product.

6. A method of manufacturing unique identifier circuits for consumable products for checking authenticity of the consumable products, comprising:
maintaining a database of unique identifiers generated during a time period; and
for each unique identifier circuit to be manufactured during the time period:
generating a unique identifier comprising a time frame portion specifying the time period, a random number portion, and an integrity check portion, for checking integrity of the unique identifier;
verifying that the unique identifier is not present in the database for the time period; and
if the unique identifier is not present in the database, storing the unique identifier in the database and in a unique identifier circuit for a consumable product.

7. The method of claim 6, wherein live time period is a bounded period of manufacturing time associated with a batch of unique identifier circuits produced during the bounded period of manufacturing time.

8. The method of claim 6, further comprising:
incrementing the time period to a second time period upon expiration of the time period, wherein unique identifiers generated during the second time period comprise a time frame portion specifying the second time period; and
deleting from the database at least some of the unique identifiers generated during the previous time period.

9. The method of claim 6, further comprising performing an integrity check of a unique identifier circuit by applying an algorithm to at least part of the unique identifier stored in the unique identifier circuit to obtain a verification result, and comparing the verification result to the integrity check portion, wherein if the verification result does not match the integrity check portion the unique identifier circuit is discarded.

10. The method of claim 6, wherein the unique identifier further comprises a location portion specifying a location where the unique identifier was generated.

11. The method of claim 6, wherein the unique identifier comprises a scheme portion specifying a scheme by which the portions of the unique identifier are to be interpreted by a device reading the identifier.

12. The method of claim 6, further comprising storing the unique identifiers in a database associated with a rewards program, the database to be used to authenticate the unique identifiers during use of the consumable products.

13. A method of authenticating the consumable product of claim 1, comprising:
reading the unique identifier from the machine-readable storage medium;
interpreting the unique identifier in accordance with a scheme identified by a scheme portion of the unique identifier;
performing a validation of the identifier based on the integrity check portion of the unique identifier;
sending the unique identifier to a server to authenticate the unique identifier; and
receiving an indication regarding the authenticity of the unique identifier from the server.

14. The method of claim 13, wherein the validation of the unique identifier is performed by:
calculating a validation value based on the unique identifier;
reading a validation identifier from the machine-readable storage medium; and
comparing the validation value to the validation identifier.

15. The method of claim 13, further comprising providing a message to a user that the consumable product is not authentic if the indication regarding the authenticity of the unique identifier indicates that the unique identifier is invalid.

16. The method of claim 13, further comprising rejecting the consumable product if the indication regarding the authenticity of the unique identifier indicates that the unique identifier is invalid.

17. The method of claim 13, further comprising sending a message to the server if the indication regarding the authenticity of the unique identifier indicates that the unique identifier is invalid, the message including location information a device performing the method.

18. The method of claim 13, wherein the unique identifier is interpreted according to a first scheme if the scheme portion identifies the first scheme and the unique identifier is interpreted according to a second scheme different from the first scheme if the scheme portion identifies the second scheme.

19. The method of claim 13, wherein the indication regarding the authenticity of the unique identifier includes rewards information, the method further comprising providing a rewards notification to a user.

20. The method of claim 13, wherein a printer performs the method and the consumable product is an ink cartridge.
